(19) United States
(12) Patent Application Publication
(10) Pub. No.: US 2023/0170774 A1
(43) Pub. Date: Jun. 1, 2023

(54) STATOR IMPREGNATION METHOD

(71) Applicant: NIDEC PSA EMOTORS, CARRIERES SOUS POISSY (FR)

(72) Inventors: Olivier BLANC, MONTSOULT (FR); Cyril MOYA, ANDEVILLE (FR)

(21) Appl. No.: 17/922,551

(22) PCT Filed: Jun. 24, 2021
(86) PCT No.: PCT/FR2021/051163

§ 371 Date: Oct. 31, 2022

(30) Foreign Application Priority Data
Jul. 21, 2020 (FR) FR2007649

(51) Int. Cl. H02K 15/12; H02K 1/16; H02K 3/34

(52) U.S. Cl. CPC H02K 15/12; H02K 1/16; H02K 3/34

(57) ABSTRACT

Method for impregnating a stator of a rotary electric machine comprising slots, electrical conductors accommodated in the slots, at least two electrical conductors being electrically connected by an electrical connection, the method comprising the following steps: a) heating the stator to a first temperature; b) applying a resin close to the slots of the stator; c) heating the stator to a second temperature; d) applying the resin to the one or more electrical connections of the electrical conductors, application steps b) and d) being achieved through flow of the resin.

### CROSS-REFERENCE TO RELATED APPLICATIONS

This application is the US National Stage under 35 USC § 371 of International Application No. PCT/FR2021/051163, filed Jun. 24, 2021 which claims the priority of French application 2007649 filed on Jul. 21, 2020, the content of which (text, drawings and claims) is incorporated here by reference.

### BACKGROUND

The present disclosure relates to methods for impregnating the stator of a rotary electric machine. Impregnating a wound stator consists in covering the electrical conductors of the stator with a resin in order to insulate them electrically, to ensure mechanical retention of the winding, and also to promote heat transfer. Impregnating the stator also includes protecting the electrical connections of the electrical conductors of the winding.

### TECHNICAL FIELD

The disclosure relates more particularly to synchronous or asynchronous AC machines. It relates in particular to traction or propulsion machines for electric motor vehicles (battery electric vehicle) and/or hybrid motor vehicles (hybrid electric vehicle—plug-in hybrid electric vehicle), such as individual cars, vans, trucks or buses. The disclosure also applies to rotary electric machines for industrial and/or energy production applications, in particular naval, aeronautical or wind power applications.

In known methods, a first resin is injected close to the slots of the stator, and a second resin, different from the first resin, is applied to the electrical connections of the electrical conductors of the wound stator in a subsequent step.

One method of causing the resin to penetrate the slots of the stator is to apply resin to the entrance of the slots. This application can in particular be done by flow. The term “trickling” is commonly used to designate this method.

To apply the resin to the electrical connections of the electrical conductors of a stator, the application of the resin can for example take place by a dipping method. In such a method, the electrical connections are immersed in a liquid resin bath. The resin is then polymerized to make it solid. The resin in the bath can also be in powder form. In this case, reference is made to a powder coating method. In this type of method, the powders used can be dangerous for operator health. It is therefore necessary to use specific equipment and procedures, in particular filters, for the handling of these products and maintenance of the equipment.

Other resin application methods are also possible, for example roll dipping, vacuum application or vacuum and pressure application.

The method of applying the resin in the slots is thus different from the method used for the resin application on the electrical connections. The use of two different application methods requires setting up two workstations, each specifically dedicated to one of the resin application methods. In general, each workstation comprises an oven intended in particular to polymerize the resin. Using two workstations requires sufficient floor space and significant energy consumption for the implementation of the method. In addition, such an installation requires providing means for transferring the stator from one station to another, such as handling arms or conveyors, for example.

In the known methods, the resin used to cover the electrical connections is generally different from that used for the impregnation. Using two different resins requires additional resources in terms of development, purchase, storage premises and floor space.

Pub. No. US 2014/209018 describes a stator impregnation method in which the same resin is applied a first time by flow over all the electrical conductors of the stator, then a second time by dipping onto the welds of the electrical conductors. Such a method requires installing a resin bath in addition to the flow device.

There is therefore a need to simplify the impregnation of a stator and reduce the costs associated therewith.

### SUMMARY

### Impregnation Method

The disclosed method aims to meet this need and it achieves this. According to one of its aspects, a method for impregnating a stator of a rotary electric machine comprising slots, electrical conductors accommodated in the slots, and at least two electrical conductors electrically connected by an electrical connection, comprises the following steps:
a) heating the stator to a first temperature,
b) applying a resin close to the entrances of the slots of the stator,
c) heating the stator to a second temperature, and
d) applying the resin to the electrical connection(s) of the electrical conductors,
wherein, application steps b) and d) being achieved through flow of the resin.

The same resin is therefore used to implement application step b) close to the slots and application step d) on the electrical connections. The method makes it possible to impregnate the stator, in particular it makes it possible to fill the slots with an impregnating resin, and it also makes it possible to protect and/or insulate the electrical connections.

The term “flow” is understood to mean a so-called “dropwise” flow, which takes place in the form of a stream of resin, in particular a continuous stream, in particular with a controlled flow rate and mass. The flow rate can for example be within the following ranges: 0.05 to 0.3 g/s, better 0.1 to 0.25 g/s, better still 0.1 to 0.2 g/s. The flow rate may for example be in the range from 0.1 to 0.16 g/s. It can for example be 0.13 g/s.

“Electrical connection” means any type of electrical connection, in particular by welding, with different possible welding methods, in particular laser, induction, friction, ultrasound, vibrations or brazing, or by mechanical clamping, in particular by crimping, screwing or riveting for example. Preferably, the weld is made without addition of material; only the constituent material of the electrical conductors is melted to form the weld. As a variant, the weld can be made with an addition of material. The welding step can be carried out by means of a heat source, in particular a laser or an electric arc, for example an electric arc produced by means of a tungsten electrode. The welding method using a tungsten electrode can be TIG (“Tungsten Inert Gas”) welding. In this welding method, the electric arc is produced from a tungsten electrode and a plasma. Using a heat source allows the free ends of the strands to be melted without damaging the assembly of the strands of the conductor(s). A single heat source can be used to produce the same weld. Alternatively, several heat sources can be used to produce the same weld.

It is considered that the resin is applied close to the slots when it is applied less than 4 cm from the slots, better still less than 3 cm, for example between 15 mm and 25 mm, being in particular applied at a distance on the order of 2 cm from the slots.

Before the method is implemented, the electrical connections are preferably “bare,” that is to say, devoid of insulation, in particular of insulating enamel. Applying a resin on the stator in particular allows the insulation of the electrical connections of the electrical conductors, which are generally bare.

Applying a resin to the electrical connections also allows the electrical conductors to be insulated from each other.

Applying a resin also allows the electrical conductors to be insulated with respect to a casing. It also improves heat transfer.

Such an application also makes it possible to improve the mechanical retention of the stator assembly.

Applying the same resin by flow close to the slots and on the electrical connections makes it possible to use the same workstation for all the stages of the method. It is thus possible to use the same tools, for example the same heating tools, in particular a single curing oven, for example, or the same resin deposition nozzles.

Owing to the method, it is possible to dispense with a workstation specific to protecting the electrical connections that is separate from the workstation for impregnating the stator. This allows a simplification of the means necessary for impregnating the stator. For example, it is possible to reduce the number of handling arms or conveyors.

In addition, such an impregnation method allows a gain in floor space with the reduction in the number of workstations necessary for its implementation compared to the methods of the prior art. The use of a single workstation, and in particular of a single curing oven, allows a reduction in energy consumption.

Such a method also allows a reduction in the time and maintenance costs of the means necessary for impregnating the stator.

Finally, the method makes it possible to dispense with the use of powders, which can be dangerous for operator health. It is thus no longer necessary to use specific filtration networks for operator safety.

Using the same resin makes it possible to reduce certain costs, in particular storage costs, since only one reference needs to be stored. The single resin used to implement the impregnation method may have a first viscosity at the first temperature and a second viscosity, greater than the first viscosity, at the second temperature.

The total time required to carry out the steps of a) heating to a first temperature, b) application close to the slots, c) heating to a second temperature and d) application on the electrical connections is less than 45 min, better still less than 30 min, better still less than 20 min, for example on the order of 10 min.

The method may also comprise the following step:
c′) heating the stator to a third temperature.

Step c′) of heating to a third temperature can be implemented after step c) of heating to a second temperature and before step d) of applying the resin to the electrical connections. As a variant, step d) of applying the resin to the electrical connections can begin before the end of step c′) of heating to a third temperature.

The third temperature can be maintained throughout step d) of applying the resin to the electrical connections. As a variant, during step d) of applying the resin to the electrical connections, the stator is heated to a fourth temperature, higher than the third temperature.

The higher the temperature of the stator, the faster the resin polymerizes when it comes into contact with the stator. Rapid polymerization of the resin makes it possible to increase the thickness of the layer of resin that is deposited on the electrical connections.

Preferably, the second temperature is higher than the first temperature. The second temperature may be higher than the first temperature by at least 10° C., more preferably by at least 15° C., more preferably by at least 20° C., more preferably by at least 25° C., more preferably by at least 30° C., more preferably by at least 35° C.

The third temperature may be either equal to or higher than the second temperature by at least 10° C., more preferably by at least 15° C., more preferably by at least 20° C., more preferably by at least 25° C., more preferably by at least 30° C., more preferably by at least 35° C., more preferably by at least 40° C.

The fourth temperature may be either equal to or higher than the third temperature by at least 10° C., more preferably by at least 15° C., more preferably by at least 20° C., more preferably by at least 25° C., more preferably by at least 30° C., more preferably by at least 35° C., more preferably by at least 40° C.

The transition from one temperature to another can be done gradually. For example, the transition from the first temperature to the fourth temperature can be done gradually. The stator temperature rise curve then does not have any plateaus. As a variant, the temperature rise curve has plateaus, for example a plateau at the first, second, third and/or fourth temperature.

Step a) of heating can begin before step b) of resin application close to the slots and continue during step b) of resin application close to the slots. As a variant, step a) of heating can stop before the start of step b) of resin application close to the slots.

Similarly, step c) of heating can begin before step d) of resin application to the electrical connections and continue during step d) of resin application to the electrical connections. As a variant, step c) of heating can stop before the start of step d) of resin application to the electrical connections.

During step b) of resin application close to the slots, the resin flows close to the slots of the stator by capillary action in order to fill them. It can also spread on the coil heads 0without necessarily reaching the electrical connections. Before step c) of heating to a second temperature, the resin finishes flowing close to the slots and polymerizes under the effect of the heat. Thus, the flow of resin close to the slots ceases. Preferably, step c) of heating to a second temperature only begins when the flow of the resin applied during step b) of resin application close to the slots has ceased.

In the case where the method comprises step c′) of heating to a third temperature, this may only begin when the flow of the resin applied during step b) of resin application close to the slots has ceased.

The time interval necessary to fill the slots, and therefore the duration to reach the start of step c), can be dependent on the length of the stator and/or the viscosity of the resin.

Preferably, the impregnation method does not have a step of dipping and/or covering, in particular by powder, of the electrical connections. The impregnation method need not require the use of a resin bath in which the stator is dipped.

During steps b) of resin application close to the slots and d) of resin application to the electrical connections, the longitudinal axis of the stator is substantially horizontal. As a variant, the longitudinal axis of the stator can be slightly inclined with respect to the horizontal. A substantially horizontal arrangement of the stator makes it possible to arrange nozzles at the two axial ends of the stator in order to impregnate on both sides with resin simultaneously. Thus, the time necessary to carry out the impregnation of the stator with resin is reduced. In addition, this positioning makes it possible to impregnate and protect the electrical connections while maintaining the substantially horizontal position of the stator. The stator impregnation method is thus facilitated.

As a further variant, the longitudinal axis of the stator is substantially vertical.

Advantageously, the stator is heated by thermal conduction[[,]] during steps a), c) and/or c′) of heating.

In a first embodiment, a stator mass of the stator is heated by induction.

Alternatively, the stator can be heated by blowing hot air (i.e, convection).

As a further variant, the heating of the stator can be carried out by applying an electric current in the electrical conductors.

Advantageously, steps b) of resin application close to the slots and d) of resin application on the electrical connections are carried out by means of at least one nozzle. The method can be implemented by means of two or more nozzles, for example two nozzles.

During steps b) of resin application close to the slots and d) of resin application on the electrical connections, the nozzle(s) can be moved along the longitudinal axis of the stator, for example in an oscillating movement. This movement allows resin to cover a larger surface of the electrical conductors of the stator. The nozzles can oscillate so that the resin is deposited between the electrical connections and the crossing of the wires with the wires of the other phases. This movement makes it possible to cover the stripped parts of the wires of the stator winding and the wire portions covered with enamel adjacent to the stripped parts. Thus, the insulation of the electrical connections is ensured even if the enamel of the wires adjacent to the stripped part of a wire is damaged.

The oscillations may have a substantially sinusoidal motion. For example, the frequency of the oscillating movement can be between 0.5 and 4 Hz, better still between 1 and 2 Hz, for example on the order of 1.2 Hz. The oscillations can have an amplitude comprised between 1 and 40 mm, better still between 1.5 and 20 mm, for example on the order of 2 mm.

Step d) of resin application to the electrical connections can be carried out in a first sub-step d1) and a second sub-step d2).

During the first sub-step step d1), the resin can be applied to the electrical connections and the bare parts of the electrical conductors, in particular the straight parts of the electrical conductors. During the first sub-step d1), the nozzle used to apply the resin can be driven in an oscillating movement. It is possible to carry out a single pass of the nozzle during the first sub-step d1). As a variant, several passes of the nozzle can be carried out during the first sub-step d1).

Then, during the second sub-step d2), the resin can be applied to the enamel of the electrical conductors in the part adjacent to the unenameled part. Preferably, a single pass of the nozzle is carried out during the second sub-step d2). As a variant, it is possible to carry out several passes of the nozzle during the second sub-step d2).

As a variant, the nozzle(s) may be so-called “duckbill” nozzles. The term “duckbill nozzle” designates a nozzle that has a rectangular cross-section, in particular at the end of the nozzle. Preferably, the longer side of the rectangular cross-section extends parallel to the longitudinal axis of the stator. The resin emerging from the duckbill nozzle(s) then covers substantially the entire surface of the electrical connections to be covered. Using such a nozzle makes it possible to increase the surface covered by the deposited resin. It is then not necessary to move the duckbill nozzles. Preferably, the duckbill nozzles are used only for step d) of resin application to the electrical connections.

In one embodiment, all the nozzles are arranged at the same end of the longitudinal axis of the stator. For example, if the method is implemented by means of two nozzles, both nozzles are arranged at the same end of the longitudinal axis of the stator. Alternatively, if the method is implemented by means of four nozzles, the four nozzles are arranged at the same end of the longitudinal axis of the stator.

The nozzles may be arranged at least 10° apart, more preferably at least 30° apart, more preferably at least 45° apart, more preferably at least 60° apart, more preferably at least 90° apart, more preferably at least 100° apart, more preferably at least 120° apart, more preferably at least 150° apart, for example substantially 180° apart.

At least one nozzle can be arranged inside the electrical conductors when the stator is observed along its longitudinal axis. At least one nozzle can be arranged outside the electrical conductors when the stator is observed along its longitudinal axis.

The nozzles may preferably be arranged such that at least one of the nozzles is arranged inside the electrical conductors and at least one other of the nozzles is arranged outside the electrical conductors when the stator is observed along its longitudinal axis. Such an arrangement of the nozzles makes it possible to reduce the risk that an area requiring protection or impregnation is not covered by the resin.

For example, if the method is implemented using two nozzles, the nozzles are arranged such that one of the nozzles is arranged inside the electrical conductors and the other is arranged outside the electrical conductors when the stator is observed along its longitudinal axis.

For example, if the method is implemented using four nozzles, the nozzles are arranged such that two of the nozzles are arranged inside the electrical conductors and the other two are arranged outside the electrical conductors when the stator is observed along its longitudinal axis.

The nozzle(s) arranged outside the electrical conductors are preferably arranged in the upper half of the cross-section located at the end of the stator when the stator is observed along its longitudinal axis. The nozzle(s) arranged inside the electrical conductors are preferably arranged in the lower half of the cross-section located at the end of the stator when the stator is observed along its longitudinal axis. Such an arrangement makes it possible to reduce the distance traveled by the resin when it leaves the nozzles to be deposited on the stator.

In a variant embodiment, at least one nozzle can be arranged at each end of the longitudinal axis of the stator. For example, if the method is implemented by means of two nozzles, one of the nozzles is arranged at a first end of the longitudinal axis of the stator and the other nozzle at a second end of the longitudinal axis of the stator. Alternatively, if the method is implemented by means of four nozzles, two of the nozzles are arranged at a first end of the longitudinal axis of the stator and the other two nozzles at a second end of the longitudinal axis of the stator. Such an arrangement thus makes it possible to deposit the resin on the two ends of the stator simultaneously. The time taken to impregnate and protect the electrical connections is thus reduced, in particular if the stator is long.

Preferably, the nozzle(s) are inclined with respect to the longitudinal axis of the stator by an angle comprised between 0 and 90°, more preferably between 10° and 80°, more preferably between 20° and 70°, more preferably between 30° and 60°, more preferably between 40° and 50°, for example substantially on the order of 45°.

When at least two nozzles are used to implement the method, all the nozzles can be oriented at the same angle relative to the longitudinal axis of the stator. Alternatively, the nozzles are oriented at different angles relative to the longitudinal axis of the stator.

Advantageously, the same nozzle(s) are used to carry out steps b) of resin application close to the slots and d) of resin application on the electrical connections. Using the same nozzles to carry out steps b) of resin application close to the slots and d) of resin application on the electrical connections makes it possible to simplify the method. This also makes it possible to make it more economical by reducing the number of tools necessary to impregnate the stator compared to the method of the state of the art.

In a variant embodiment, steps b) of resin application close to the slots and d) of resin application on the electrical connections can be carried out by means of at least one nozzle; different nozzles can be used to carry out step b) of resin application in the slots (21) and d) of resin application on the electrical connections. The same nozzle(s) may not be used to carry out step b) of resin application close to the slots and d) of resin application on the electrical connections. For example, if the method is implemented using four nozzles, two nozzles can be dedicated to applying the resin close to the slots and the other two nozzles can be dedicated to applying the resin on the electrical connections. Preferably, the nozzles dedicated to applying the resin close to the slots and the nozzles dedicated to applying the resin to the electrical connections do not operate simultaneously.

In one embodiment of the method, two nozzles can be arranged on the side of the axial end of the stator that comprises the electrical connections and another nozzle can be arranged at the other axial end of the stator. On the side of the axial end that comprises the electrical connections, one of the nozzles can be used to apply resin close to the slots and the other nozzle can be used to apply the resin to the electrical connections. The nozzle arranged at the other axial end of the stator can be used to apply the resin close to the slots. Resin can thus be applied in the slots from both axial ends of the stator. The stator can thus be impregnated more quickly.

Preferably, a step of translation of the nozzle(s), in particular parallel to the longitudinal axis of the stator, can be carried out between steps b) of resin application close to the slots and d) of resin application on the electrical connections.

When the same nozzle(s) are not used to carry out step b) of resin application close to the slots and d) of resin application on the electrical connections, the step of translation of the nozzle(s) may not take place. The nozzles can for example be arranged beforehand so that at least one nozzle allows the application of the resin close to the slots and at least one other nozzle allows the application to the electrical connections.

The same workstation can be used to carry out steps b) of resin application close to the slots and d) of resin application on the electrical connections without requiring the nozzles to be changed.

Preferably, the nozzles are translated along the longitudinal axis of the stator by a distance of between 0.3 and 10 cm, better still between 0.5 and 5 cm, for example by a distance on the order of 2 or 4 cm.

When performing step b) of resin application close to the slots, the gap between the entrance of the slots and the end of the nozzle is preferably between 0.1 and 4 cm, better still between 0.5 and 3 cm, for example a distance on the order of 2 cm.

Step b) of resin application close to the slots can be carried out by means of two nozzles. A first nozzle may be located at one axial end of the stator inside the electrical conductors and a second nozzle may be located at the other axial end of the stator outside the electrical conductors. Step b) of resin application close to the slots may comprise the following steps:
b1) applying the resin close to the slots,
b2) moving the nozzles so that the first nozzle is located outside the electrical conductors and the second nozzle is located inside the electrical conductors, and
b3) applying the resin close to the slots.

Then, another nozzle can be used to perform step d) of resin application to the electrical connections.

When performing step d) of resin application to the electrical connections, the gap between the electrical connections and the end of the nozzle is more preferably between 0.1 and 4 cm, more preferably between 0.5 and 3 cm, for example a distance on the order of 2 cm.

When performing step d) of resin application to the electrical connections, the gap between the entry of the slots and the end of the nozzle is more preferably between 0.1 and 4 cm, more preferably between 0.3 and 3.5 cm, more preferably between 0.5 and 3 cm, for example a distance on the order of 2 cm.

The stator can be rotated. Preferably, the stator is driven in rotation during steps a) and c) of heating, of step b) of resin application close to the slots and d) of resin application on the electrical connections. As a variant, the stator is driven in rotation only during steps b) of resin application close to the slots and d) of resin application on the electrical connections.

Such a rotation of the stator makes it possible to produce a uniform deposition of the resin over the entire circumference of the stator. Furthermore, the rotation of the stator makes it possible to avoid casting resin in particular next to the stator, and to promote the penetration of the resin into the slots by capillary action.

The stator can rotate on itself at a speed between 3 and 55 rpm, more preferably between 5 and 40 rpm, more preferably between 7 and 35 rpm, more preferably between 10 and 30 rpm, more preferably between 13 and 25 rpm, for example on the order of 15 rpm.

The impregnation method may comprise the following additional step:
e) polymerizing the resin deposited close to the slots of the stator and on the electrical connections.

The resin is for example polymerized by heating. This polymerization step makes it possible to change the state of the resin. In the case where the resin used is a thermosetting resin, step e) of polymerization thus makes it possible to make [[it]] the resin solid in an irreversible manner.

A single step e) of polymerization can be carried out after steps a) and c) of heating, step b) of resin application close to the slots and step d) of resin application on the electrical connections. As a variant, a first step e) of polymerization can be carried out after the first step b) of resin application close to the slots and a step e) of polymerization can again be carried out after step d) of resin application on the electrical connections.

The polymerization of the resin preferably takes place in a suitable oven. As a variant, the heating can be done by induction or by blowing hot air. Polymerization of the resin may be partly due to the heating of the stator in steps a) and c). Owing to the method, the polymerization of the resin applied during step b) of resin application close to the slots and of the resin applied during step d) of resin application on the electrical connections can be done simultaneously. A single curing oven may therefore be necessary to impregnate the stator and to protect its electrical connections.

Preferably, the polymerization temperature is between 120 and 300° C., or even between 125 and 280° C., more preferably between 130 and 250° C., even between 135 and 210° C., more preferably between 140 and 190° C., more preferably between 145 and 185° C., more preferably between 150 and 180° C., more preferably between 155 and 175° C., for example on the order of 170°.

The polymerization time can be between 15 and 60 minutes, more preferably between 25 and 45 minutes, for example on the order of 35 minutes.

As a variant, step e) of polymerization is carried out using a catalyst. In this case, the resin(s) may not be heated.

Preferably, the first temperature is between 80 and 160° C., more preferably between 85 and 155° C., more preferably between 90 and 150° C., more preferably between 95 and 145° C., more preferably between 100 and 140° C., more preferably between 105 and 135° C., more preferably between 110 and 130° C., for example on the order of 120° C. Such a temperature range makes it possible to retain a substantially fluid resin and the capillary action effect. [[It]] The resin can thus flow easily into the slots. The stator can then be impregnated more quickly.

The first temperature may be above 80°, more preferably above 85° C., more preferably above 90° C., more preferably above 95° C., more preferably above 100° C., more preferably above 105° C., more preferably above 110° C., more preferably above 115° C.

The first temperature may be less than 160°, more preferably less than 155° C., more preferably less than 150° C., more preferably less than 145° C., more preferably less than 140° C., more preferably less than 135° C., more preferably less than 130° C., more preferably less than 125° C.

Preferably, the second temperature is between 110 and 190° C., more preferably between 115 and 185° C., more preferably between 120 and 180° C., more preferably between 125 and 175° C., more preferably between 130 and 170° C., more preferably between 135 and 165° C., more preferably between 145 and 165° C., for example on the order of 160° C. In this temperature range, the resin is polymerized more quickly, in particular in contact with hot copper. This faster polymerization makes it possible to be able to deposit a thicker layer of resin on the electrical connections and thus allows good protection and insulation of the electrical connections.

The second temperature may be higher than 110°, more preferably higher than 115° C., more preferably higher than 120° C., more preferably higher than 125° C., more preferably higher than 130° C., more preferably higher than 135° C., more preferably higher than 140° C., more preferably higher than 145° C., more preferably higher than 150° C., more preferably higher than 155° C.

The second temperature may be less than 190°, more preferably less than 185° C., more preferably less than 180° C., more preferably less than 175° C., more preferably less than 170° C., more preferably less than 165° C.

The resin need not be heated before it is deposited on the stator; for example, it is not heated beforehand in a tank before it is applied to the stator. The temperature of the resin rises in contact with the stator, which is heated.

Preferably, before the resin is applied, it is maintained at a fixed temperature, for example a temperature on the order of 25° C. Maintaining such a temperature makes it possible to prevent it from starting to polymerize before it is applied to the stator, which would make its application more difficult. In order to maintain the resin at a fixed temperature, it can be refrigerated; alternatively, it can also be heated.

Advantageously, a layer of resin with a thickness of between 0.05 mm and 2 mm, more preferably between 0.25 and 1 mm, for example on the order of 0.50 mm, is applied to the electrical connections.

The method makes it possible to apply a larger layer of resin on the electrical connections than the methods of the prior art. The insulation and the mechanical retention of the electrical connections is thus improved. Applying a layer of sufficient thickness to ensure the insulation of the electrical connections makes it possible not to have to use an additional insulating element, such as for example paper or a different resin deposited by another method such as dipping or powder coating, to insulate the electrical connections.

The viscosity of the resin before it is applied to the stator during step b) of resin application close to the slots or d) of resin application on the electrical connections is the same. It is in contact with the stator, which is heated, that the resin heats up and can begin to polymerize. Its viscosity is thus modified in contact with the stator. Since the temperature of the stator during step b) of resin application close to the slots or d) of resin application on the electrical connections is not the same, the viscosity of the resin in contact with the stator during these two steps is also not the same. Before the resin is applied on the stator, its viscosity and temperature remain constant.

The viscosity of the resin in contact with the stator at the second temperature can be higher than the viscosity of the resin in contact with the stator at the first temperature.

Preferably, the resin is sufficiently fluid in contact with the stator during step b) of resin application close to the slots of the stator to allow [[it]] the resin to flow into the slots of the stator in order to fill them.

Preferably, the resin is more viscous in contact with the stator during step d) of resin application to the electrical connections than during step b) of resin application close to the slots. This higher viscosity makes it possible to deposit a larger layer of resin on the electrical connections. In addition, the viscosity of the resin in contact with the stator at the second temperature is high enough for the resin not to flow into the slots during step d) of resin application to the electrical connections.

This difference in viscosity of the resin, when it comes into contact with the stator heated to the two distinct application temperatures, makes it possible to simplify the application on the electrical connections while limiting the risk of deposition next to the electrical connections, which requires workstation cleaning.

The resin that is in contact with the stator can remain sufficiently fluid during step d) of resin application to the electrical connections to penetrate between the electrical conductors of the stator, in particular between the free ends of the electrical conductors.

The resin used to implement the method is more fluid than the products usually used. Thus, [[it]] the resin penetrates better between the junctions and the wires, and thus allows better electrical insulation and better mechanical retention.

Preferably, the resin is thermosetting. The term “thermosetting” means that the resin polymerizes, for example under the effect of heat, to pass irreversibly to the solid state.

Preferably, the resin may not be a two-component resin.

The resin may comprise at least one polyester, in particular a polyester-imide.

Preferably, the resin comprises at least one polyester, in particular a polyester-imide.

Such a resin has the particular advantage of exhibiting good adhesion to bare copper, which facilitates its application to the ends of the electrical conductors in order to protect the electrical connections.

The resin may comprise one or more additives, for example to improve its crosslinking.

The resin may comprise at least one epoxy polymer. Alternatively, the resin may not comprise epoxy polymer.

Preferably, the resin used for the impregnation method is a single-component resin. Alternatively, it is a two-component resin.

Preferably, at least some of the electrical conductors, like a majority of the electrical conductors, are in pin form, in U-pins or I-pins.

### Stator

A further object, independently or in combination with the foregoing, is a method for impregnating an electric machine stator.

The resin layer of the stator is regular throughout its thickness. It thus may not have several layers separated by one or more visible demarcations.

Conversely, a stator impregnated by a combination of flow and dip application has a layer of resin on its electrical connections that has a demarcation, for example a bead or a color difference, between the flow-deposited layer and the layer deposited by dipping.

The layer of resin resulting from the impregnation method can be composed of a single resin. Alternatively, the resin layer is composed of two different resins.

In addition, independently or in combination with the foregoing, [[to]] a stator is disclosed for a rotary electric machine comprising a stator mass comprising slots, electrical conductors accommodated in the slots, at least two electrical conductors that are electrically connected, and comprising a resin comprising at least one polyester, in particular a polyester-imide, filling the slots and covering the electrical connections.

The thickness of the resin layer covering the electrical connections can be between 0.05 mm and 2 mm, more preferably between 0.25 and 1 mm, for example on the order of 0.5 mm.

### Machine and Stator

A rotary electric machine comprising a stator as defined above is also disclosed. The machine can be used as a motor or as a generator. The machine can be a reluctance machine. It can constitute a synchronous motor or, as a variant, a synchronous generator. As a further variant, it constitutes an asynchronous machine.

The maximum speed of rotation of the machine can be high, being for example greater than 10,000 rpm, better still greater than 12,000 rpm, being for example on the order of 14,000 rpm to 15,000 rpm, or even 20,000 rpm or 24,000 rpm. The maximum speed of rotation of the machine may be less than 100,000 rpm, or even 60,000 rpm, or even less than 40,000 rpm, better still less than 30,000 rpm.

The machine comprises a rotor. The machine may comprise a single inner rotor or, as a variant, an inner rotor and an outer rotor, arranged radially on either side of the stator and coupled in rotation.

The machine can work alone or be coupled to a gearbox. In this case, it is inserted in a casing that also accommodates a gearbox.

The stator may comprise teeth defining slots between them. At least some of the electrical conductors, if not a majority of the electrical conductors, can be in the form of U-pins or I-pins.

The slots can be at least partially closed. A partially closed slot makes it possible to provide an opening at the air gap, which can be used, for example, to install the electrical conductors for filling the slot. A partially closed slot is in particular formed between two teeth that each comprise pole shoes at their free end, which close the slot at least in part.

In a variant, the slots can be completely closed. The term “fully closed slot” denotes slots that are not open radially toward the air gap.

In one embodiment, at least one slot, or even each slot, can be continuously closed on the side of the air gap by a material bridge formed in one piece with the teeth defining the slot. All the slots can be closed on the side of the air gap by material bridges closing the slots. The material bridges may have come in one piece with the teeth defining the slot. The stator mass is then devoid of any cutout between the teeth and the material bridges closing the slots, and the slots are then continuously closed on the side of the air gap by the material bridges coming in one piece with the teeth defining the slot.

In addition, the slots can also be closed on the side opposite the air gap by an attached yoke or in one piece with the teeth. The slots are then not radially outwardly open. The stator mass may have no cutout between the teeth and the yoke.

In one embodiment, each of the slots has a continuously closed contour. “Continuously closed” means that the slots have a continuous closed contour when viewed in cross-section, taken perpendicular to the axis of rotation of the machine. It is possible to go all the way around the slot without encountering a cutout in the stator mass.

The stator may comprise a stator mass. The stator mass can be produced by stacking magnetic sheets, the slots being formed by cutting the sheets. In a variant, the stator mass can be produced by cutting from a mass of sintered or agglomerated magnetic powder. The closing of the slots on the side of the air gap is obtained by material bridges in one piece with the rest of the sheets or of the block forming the stator mass.

The stator may not have any attached magnetic shims for closing the slots. This eliminates the risk of accidental detachment of these shims.

The stator may comprise coils arranged in a distributed manner in the slots, in particular having electrical conductors arranged in a row in the slots. “Distributed” means that at least one of the coils passes successively through two non-adjacent slots.

The electrical conductors may not be arranged in the slots in bulk, but in an orderly manner. They are stacked in the slots in a non-random manner, for example arranged in rows of aligned electrical conductors. The stack of electrical conductors is for example a stack according to a hexagonal network in the case of electrical conductors of circular cross-section.

The stator may comprise electrical conductors accommodated in the slots. At least some electrical conductors, if not a majority of the electrical conductors, can be in the form of U or I pins. The pin can be U-shaped (“U-pin”) or straight, being I-shaped (“I-pin”).

Each electrical conductor may comprise one or more strands (also called “wire”). “Strand” refers to the most basic unit for electrical conduction. A strand can be of round cross-section, which may then be called “wire,” or may be flat. The flat strands can be shaped into pins, for example U or I pins. Each strand is coated with an insulating enamel.

The electrical conductors can form a single winding, in particular whole or fractional. “Single winding” means that the electrical conductors are electrically connected together in the stator, and that the connections between the phases are made in the stator, and not outside the stator, for example in a terminal box. A winding is made up of a number of phases m offset in space in such a way that when supplied by a multi-phase current system, they produce a rotating field. The winding can be whole or fractional. The winding can be whole in pitch with or without shortening, or fractional in a variant. In one embodiment, the electrical conductors form a fractional winding, in particular with a shortened pitch.

The winding can be wavy. The electrical conductors can be placed in series in a so-called wave winding. The term “wave winding” is understood to mean a winding in which the electrical conductors of the same phase and of the same pole are electrically connected to one another so that, for a winding path, the electric current of the phase circulates in the electrical conductors rotating about the axis of rotation of the machine, always in one direction. For a winding path, the electrical conductors of the same phase and the same pole do not overlap when observed perpendicular to the axis of rotation of the machine.

The winding may comprise a single winding path or several winding paths. The current of the same phase flows by winding path in an “electrical conductor.” “Winding path” means all the electrical conductors of the machine that are traversed by the same electric current of the same phase. These electrical conductors can be connected to each other in series or in parallel or in series-parallel. In the case where there is only one path, the electrical conductors are connected in series. In the case where there are several paths, the electrical conductors of each path are connected in series, and the paths are connected in parallel.

The electrical conductors can thus form a distributed winding. The winding may not be concentrated or wound on a tooth.

In a variant embodiment, the stator has a concentrated winding. The stator may comprise teeth and coils arranged on the teeth. The stator can thus be wound on teeth, in other words, with undistributed winding.

The teeth of the stator may comprise pole shoes. As a variant, the teeth of the stator do not have pole shoes.

The stator may comprise an outer frame surrounding the yoke.

The teeth of the stator can be made with a stack of magnetic sheets, each covered with an insulating varnish, in order to limit the losses by induced currents.

### BRIEF DESCRIPTION OF THE DRAWINGS

FIG. 1 is a schematic and partial perspective view of a stator produced in accordance with the disclosed method,

FIG. 2 is a schematic and partial perspective view of the stator of FIG. 1,

FIG. 3 is a detail perspective view of the stator of FIG. 1,

FIG. 4 is a diagram illustrating the different steps of the method,

FIG. 5a is a perspective view of the stator during the step of applying the resin in its slots,

FIG. 5b is a perspective view of the stator during the step of applying the resin to the electrical connection(s) of the electrical conductors,

FIG. 6 is a sectional view of the stator,

FIG. 7a is a view similar to FIG. 5a of an alternative embodiment,

FIG. 7b is a view similar to FIG. 5b of an alternative embodiment,

FIG. 8a is a view similar to FIG. 7a of an alternative embodiment,

FIG. 8b is a view similar to FIG. 7b of an alternative embodiment,

FIG. 9a is a view similar to FIG. 5a of an alternative embodiment,

FIG. 9b is a view similar to FIG. 5a of an alternative embodiment,

FIG. 9c is a view similar to FIG. 5b of an alternative embodiment.

### DETAILED DESCRIPTION

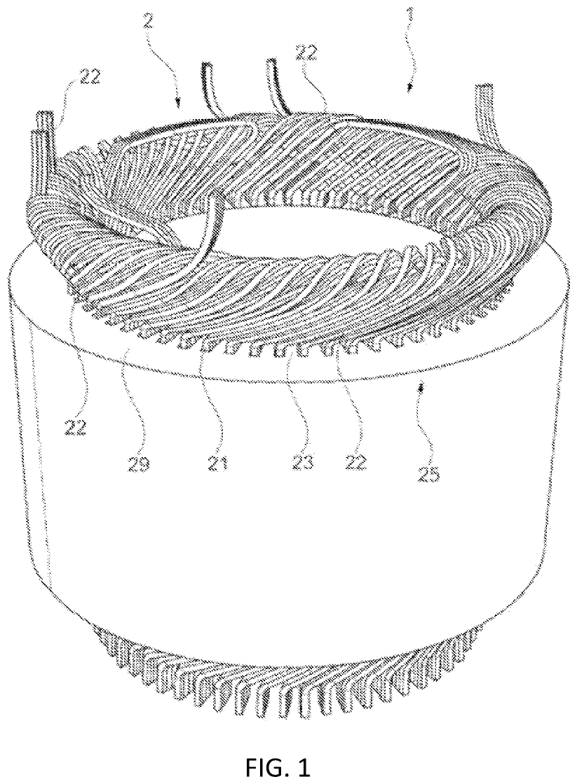

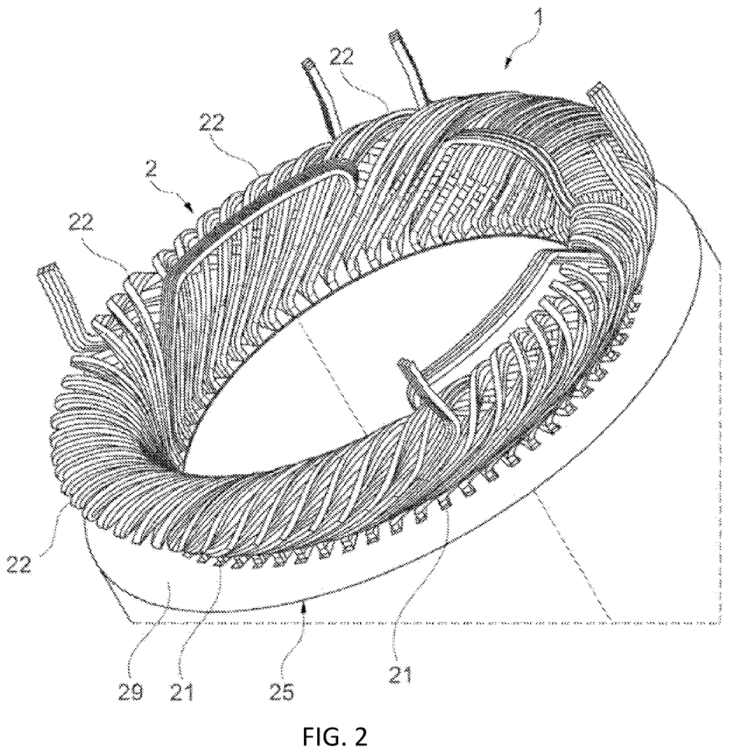

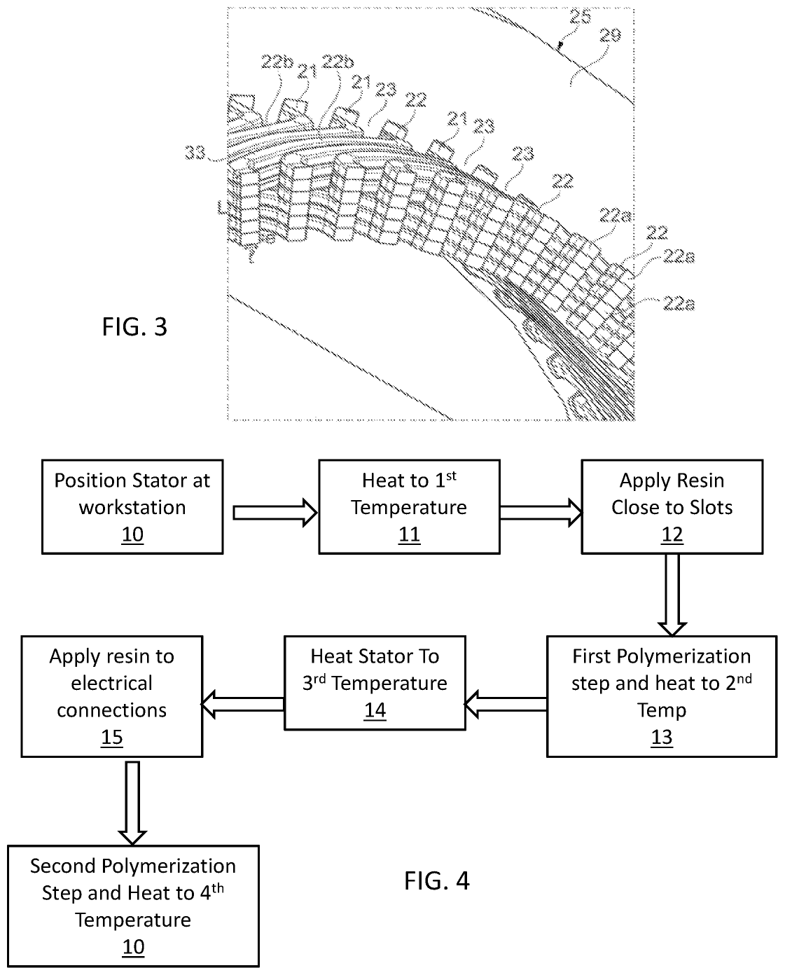

FIGS. 1 to 3 show a stator 2 of a rotary electric machine 1 also comprising a rotor, not shown. The stator makes it possible to generate a rotating magnetic field for driving the rotating rotor, in the context of a synchronous motor, and in the case of an alternator, the rotation of the rotor induces an electromotive force in the electrical conductors of the stator.

The examples illustrated below are schematic and the relative dimensions of the various component elements have not necessarily been observed.

The stator 2 comprises electrical conductors 22, which are arranged in slots 21 formed between teeth 23 of a stator mass 25. The slots 21 are closed.

The electrical conductors 22 comprise strands 33. The strands 33 have a generally rectangular cross-section, in particular with rounded corners. In the described example, the strands 33 are superimposed radially in a single row.

The thickness e of a strand 33 is its dimension in the radial direction of the machine. The width/of a strand 33 is defined as its dimension in the circumferential direction about the axis of rotation of the machine. The width L of the section to be welded corresponds to the sum of the thicknesses e of each strand.

The electrical conductors 22 are for the most part in the form of pins, namely U or I pins, and extend axially in the slots. A first electrical conductor accommodated in a first slot is electrically connected to a second electrical conductor accommodated in a second slot, at the outlet from said slots.

The first and second slots are non-consecutive. In the illustrated example, they are separated by 7 other slots. In a variant, the first and second slots are separated by 3, 4, 5, 6, 8, 9, 10 or 11 other slots, for example.

The electrical connection is formed on the electrical conductors just after they exit the two slots, at one axial end of the stator mass. The two electrical conductors each comprise an oblique portion 22b, which converge toward one another.

The electrical connection between two conductors is done in a plane perpendicular to the axis of rotation of the machine, causing the free ends 22a of the strands of the two electrical conductors to melt.

FIG. 4 is a diagram illustrating the various steps of the method implemented to impregnate the stator.

After the stator has been wound, it is placed on a workstation dedicated to its impregnation during a step 10. After the stator is positioned, it is heated to a first temperature during the heating step 11. During this step, the stator is rotated, for example at a speed of rotation on the order of 15 rpm.

When the stator has reached a temperature substantially equal to the first temperature, the resin is applied close to the slots during a first application step 12. During this application step, the applied resin flows into the slots 21 by capillary action in order to fill them.

This first application step 12 is followed by a first polymerization step 13 of the resin applied in step 12. During this first polymerization step 13, the stator continues to be heated to reach a second temperature higher than the first temperature. During this first polymerization step 13, the resin applied in step 12 begins to polymerize and thus begins its transformation toward the solid state. Polymerization of the resin is possible owing to the heat from the stator. The first polymerization step 13 lasts between 0 and 20 min, more preferably between 5 and 15 min, for example on the order of 10 min. At the end of the first polymerization step 13, substantially all of the resin is polymerized, and its flow into the slots 21 of the stator has stopped. At the end of the polymerization step 13, there is no more resin applied close to the slots of the stator.

After the polymerization step 13, that is to say, when the flow of resin has stopped, the stator continues to be heated during a new heating step 14 up to a third temperature, higher than the second.

Once the stator has reached a temperature substantially equal to the third temperature, a second application step 15 takes place. During this second application step 15, the resin is applied to the electrical connection(s) of the electrical conductors 22.

Finally, a second polymerization step 16 of the resin applied to the stator is carried out by heating the stator to a fourth temperature higher than or equal to the third temperature. The second polymerization step 16 is preferably carried out in a suitable oven. The fourth polymerization temperature is for example between 130 and 280° C., more preferably between 135 and 205° C., more preferably between 130 and 200° C., more preferably between 135 and 195° C., more preferably between 140 and 190° C., more preferably between 145 and 185° C., more preferably between 150 and 180° C., more preferably between 155 and 175° C., for example on the order of 170°. The polymerization time can be between 15 and 60 minutes, more preferably between 25 and 45 minutes, for example on the order of 35 minutes. This second polymerization step 16 makes it possible to change the state of the resin applied to the electrical connections. In the case where the resin used is thermosetting, it thus makes it possible to make it irreversibly solid.

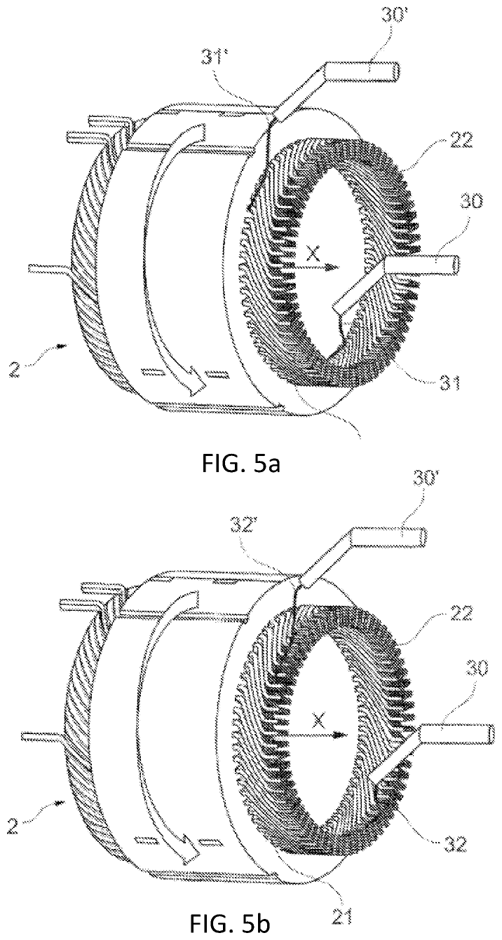

The application steps 12 and 15 will now be detailed with reference to FIGS. 5a and 5b.

FIG. 5a illustrates the first application step 12, during which the resin is applied close to the slots 21 of the stator. In the example shown, this application step 12 is carried out by flow by means of two nozzles 30, 30′. The two nozzles 30, 30′ are arranged at substantially 180° from each other. The nozzle 30 is arranged inside the electrical conductors, in the lower part of the cross-section located at the end of the stator, when the stator is observed along its longitudinal axis X. The other nozzle 30′ is arranged outside the electrical conductors, in the upper part of the cross-section located at the end of the stator, when the stator is observed along its longitudinal axis X.

During the first application step 12 shown in FIG. 5a, the two nozzles 30, 30′ allow the deposition of streams 31, 31′ of resin close to the entrance to the slots 21 of the stator. The resin thus deposited will penetrate the slots 21, in particular due to capillary action. The resin will also spread over the coil heads without necessarily reaching the electrical connections.

The nozzle 30 deposits the stream 31 of resin at the inner circumference of the slots. The nozzle 30′ deposits the stream 31′ of resin at the inner circumference of the slots.

The second application step 15 is illustrated in FIG. 5b. To go from the first application step 12 to the second application step 15, the nozzles 30, 30′ are translated, for example in a direction parallel to the longitudinal axis X of the stator, in order to separate them from the stator. For example, the nozzles 30, 30′ are translated along the longitudinal axis X of the stator by a distance of between 0.3 and 10 cm, better still between 0.5 and 5 cm, for example by a distance on the order of 2 or 4 cm. The nozzles 30, 30′ thus translated are each suitable for depositing a stream 32, 32′ of resin on the electrical connections of the electrical conductors 22.

In the example of FIG. 5b, the arrangement of the nozzles 30, 30′ relative to each other during the second application step 15 is identical to that of the first application step 12 illustrated in FIG. 5a.

During the second application step 15 shown in FIG. 5b, the two nozzles 30, 30′ allow the deposition of streams 32, 32′ of resin on the electrical connections of the electrical conductors 22.

In this embodiment, the same nozzles 30, 30′ are used to apply the same resin close to the slots of the stator and on the electrical connections. Using the same nozzles makes it possible to reduce the size of the resin application device. Using the same resin makes it possible not need to modify the supply of the nozzles 30, 30′ with resin between the first application step 12 and the second application step 15.

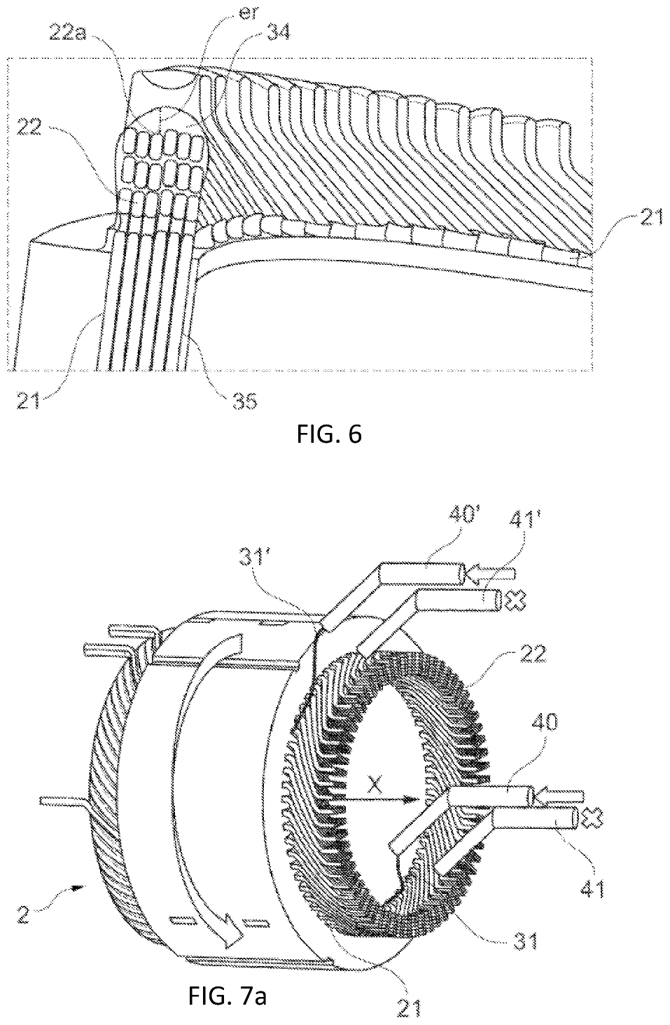

FIG. 6 shows the stator obtained by the impregnation method detailed with reference to FIGS. 4, 5a and 5b. This stator has a layer of resin 34 on the electrical connections of thickness er. As illustrated in FIG. 6, the thickness er of the resin layer 34 is measured from the free ends 22a of the electrical conductors 22. The thickness er of the resin layer 34 covering the electrical connections of the electrical conductors 22 is between 0.05 mm and 2 mm, more preferably between 0.25 and 1 mm, for example on the order of 0.5 mm. The resin layer 34 covers almost the entire surface of the electrical conductors 22, which is devoid of insulating enamel. The resin layer 34 of the stator is regular over its entire thickness er. The resin layer 34 of thickness er improves the electrical and mechanical rigidity of the assembly.

As visible in FIG. 6, a layer of resin 35 is deposited close to the slots 21. This layer makes it possible to mechanically retain the electrical conductors 22 in the slots by filling the empty spaces before impregnation.

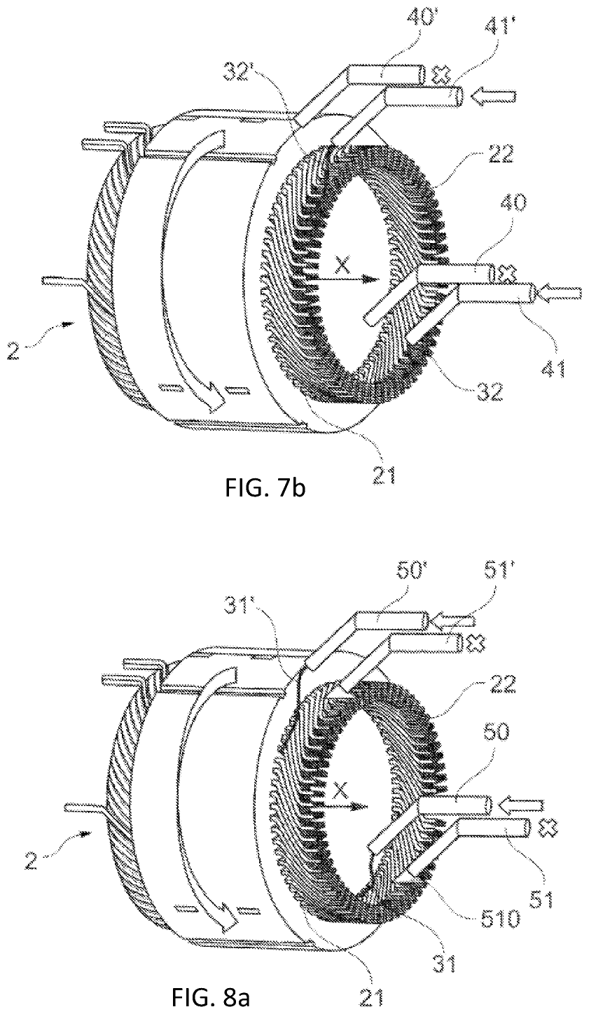

FIGS. 7a and 7b illustrate an alternative embodiment of the method. In this embodiment, the first and second application steps 12, 15 are carried out by means of four nozzles 40, 40′,41, 41′. Preferably, the four nozzles 40, 40′,41, 41′ are arranged at the same end of the longitudinal axis X of the stator. The nozzles 40, 40′ are arranged at substantially 180° from each other. Similarly, the nozzles 41, 41′ are arranged at substantially 180° from each other. The nozzles 40 and 41 on the one hand and 40′ and 41′ on the other hand are arranged at substantially 20° from each other. The nozzles are inclined with respect to the longitudinal axis X of the stator by an angle substantially on the order of 45°. The nozzles are arranged in such a way that two nozzles 40, 41 are arranged inside the electrical conductors and the other two nozzles 40′,41′ are arranged outside when the stator is observed along its longitudinal axis X.

In this embodiment, the resin is not applied by the same nozzles during the first 12 and the second 15 application steps. Two of the nozzles 40, 40′ serve for example to apply the resin close to the slots of the stator, and the other two 41, 41′ serve for example to apply the resin to the electrical connections.

The two nozzles 40, 40′ allow streams 31, 31′ of resin to be deposited at the entrance to the slots 21 of the stator. The resin thus deposited will penetrate the slots 21, in particular by capillary action. The resin will also spread over the coil heads without necessarily reaching the electrical connections.

The nozzle 40 can deposit the stream 31 of resin at the inner circumference of the slots. The nozzle 40′ can deposit the stream 31′ at the inner circumference of the slots.

The second application step 15 of this four-nozzle embodiment is illustrated in FIG. 7b.

The arrangement of the nozzles 40, 40′,41, 41′ with respect to one another during the second application step 15 is identical to that of the first application step 12 illustrated in FIG. 7a.

During the second application step 15 shown in FIG. 7b, the two nozzles 41, 41′ allow the deposition of streams 32, 32′ of resin on the electrical connections of the electrical conductors 22.

This embodiment with four nozzles, each pair of which is dedicated to the application of the resin either close to the slots of the stator or on the electrical connections, has the advantage that it is not necessary to translate the nozzles between the two application steps. This makes it possible to implement the method more quickly.

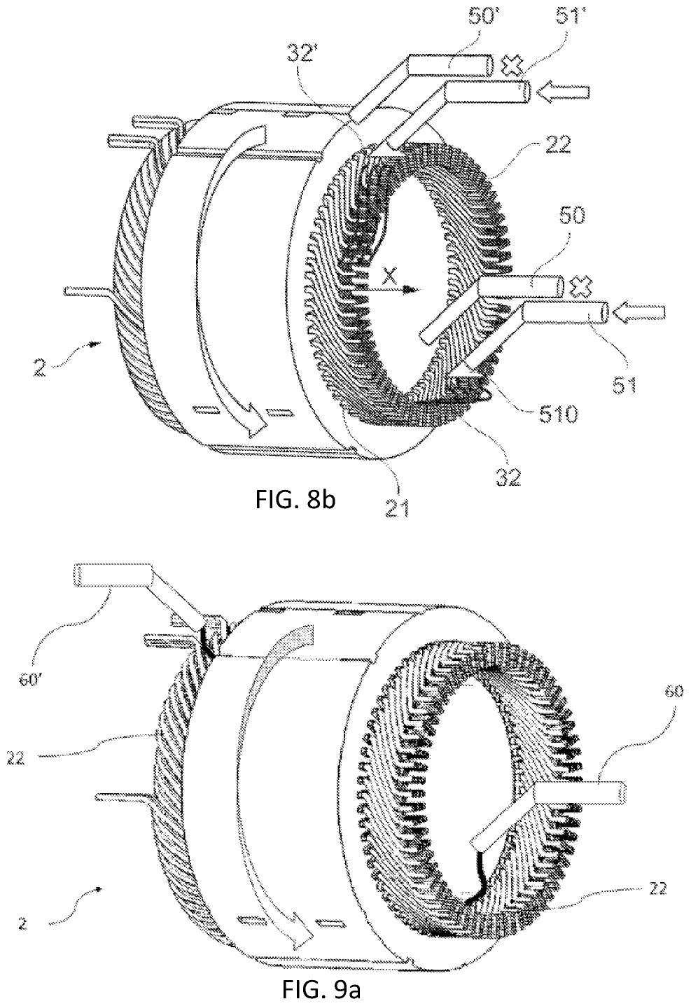

The embodiment shown in FIGS. 8a and 8b is a variant of the embodiment with four nozzles, each pair of which is dedicated to the application of the resin to a given area of the electrical conductors of the stator.

In this variant, the nozzles 50, 50′ used for application close to the slots of the stator and the nozzles 51, 51′ used for application on the electrical connections are different. For example, the nozzles 51, 51′ dedicated to applying the resin to the electrical connections are duckbill nozzles 510. In the illustrated embodiment, the longer side of the rectangular cross-section extends parallel to the longitudinal axis of the stator. Such a nozzle makes it possible to apply streams 32, 32′ of resin that are wider than those of the nozzles 50, 50′ of rectangular cross-section. The resin leaving the nozzles 51, 51′ then covers substantially the entire surface of the electrical connections to be covered.

The nozzles 50, 50′ used for resin application close to the slots of the stator, for their part, are for example of circular cross-section. It is not necessary to use duckbill nozzles for application of the resin to the entrance of the slots since it will migrate to fill the slots. In addition, the nozzles of circular cross-section are less bulky than the duckbill nozzles; it is therefore advantageous to use these two types of nozzles to implement the impregnation method.

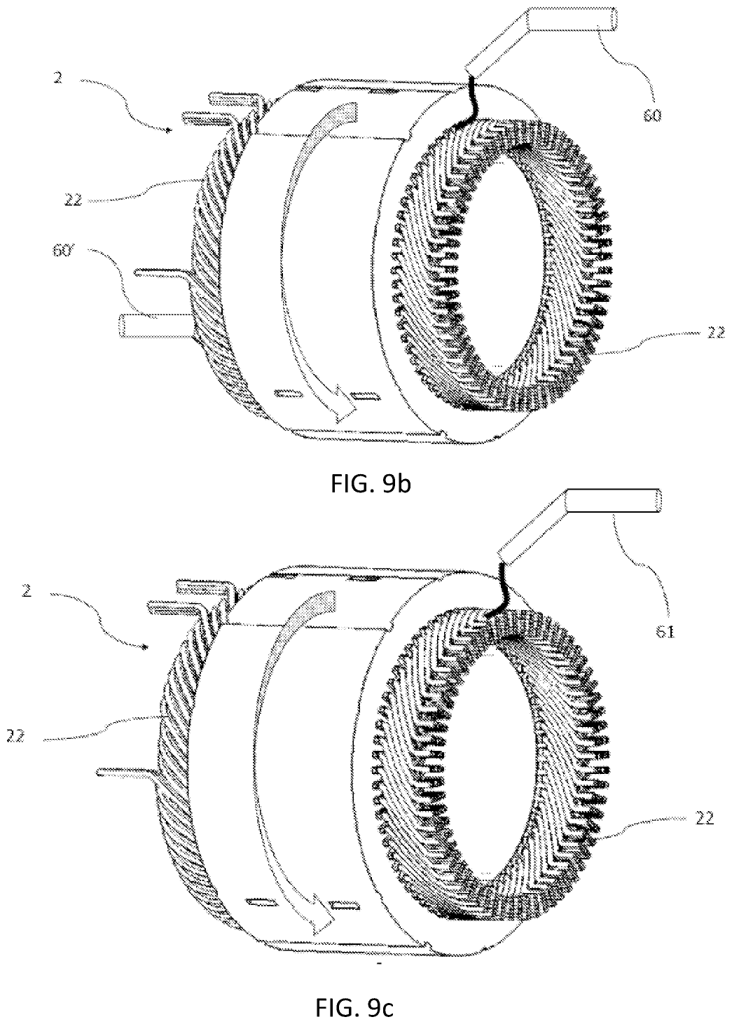

In the embodiment of FIGS. 9a, 9b and 9c, the resin is applied by three nozzles 60, 60′,61. Two first nozzles 60 and 60′ are dedicated to applying a resin in the slots of the stator to carry out the impregnation. The second nozzle 61 is dedicated to applying a resin to the electrical connections.

The first two nozzles 60, 60′ are arranged at each of the two axial ends of the stator. One of the nozzles is arranged inside the electrical conductors when the stator is observed along its longitudinal axis and the other is arranged outside the electrical conductors. For example, in a first step, illustrated in FIG. 9a, the nozzle 60′ is placed outside the electrical conductors and the nozzle 60 is placed inside the electrical conductors. Then, in a second step, illustrated in FIG. 9b, the arrangement of the nozzles is reversed, that is to say, the nozzle 60′ is arranged inside the electrical conductors and the nozzle 60 is arranged outside the electrical conductors. This displacement of the nozzles makes it possible to improve the filling of the slots.

After the resin is applied in the slots, the second nozzle 61, visible in FIG. 9c, is put into operation to apply resin to the electrical connections. This second nozzle 61 is arranged on the side of the stator that comprises the electrical connections.

In the embodiment that has just been described, the same nozzles are not used to apply the resin in the slots and to apply it on the electrical connections. These steps can thus be done simultaneously on two different stators to reduce production time.

Of course, the claimed invention is not limited to the embodiments that have just been described, and the rotor associated with the described stator can be wound, with a squirrel cage or with permanent magnets, or else with variable reluctance.

1. A method for impregnating a stator of a rotary electric machine comprising slots, electrical conductors accommodated in the slots, and at least two electrical conductors being electrically connected by an electrical connection, the method comprising the following steps:
a) heating the stator to a first temperature,
b) applying a resin close to the slots of the stator,
c) heating the stator to a second temperature,
d) applying the resin to the electrical connections of the electrical conductors,
application steps b) and d) being achieved through flow of the resin,
the longitudinal axis of the stator being substantially horizontal or slightly inclined with respect to the horizontal.

2. A method for impregnating a stator of a rotary electric machine comprising slots, electrical conductors accommodated in the slots, at least two electrical conductors being electrically connected by an electrical connection, the method comprising the following steps:
a) heating the stator to a first temperature,
b) applying a resin close to the slots of the stator,
c) heating the stator to a second temperature higher than the first temperature,
d) applying the resin to the electrical connection of the electrical conductors,
application steps b) and d) being carried out by flowing of the resin,
step c) of heating to a second temperature beginning before step d) of application to the electrical connections.

3. The method according to one of the two claim 1, comprising the following step:
c′) heating the stator to a third temperature.

4. The method according to claim 1, the stator being heated by thermal conduction during steps a) and/or c) of heating.

5. The method according to claim 1, step b) of application close to the slots and step d) of application on the electrical connections being carried out by means of at least one nozzle, different nozzles being used to carry out step b) of application in the slots and step d) of application on the electrical connections.

6. The method according to claim 5, further comprising a step of translation of the nozzle(s) which is carried out between step b) of application close to the slots and step d) of application on the electrical connections.

7. The method according to claim 5, step b) of application close to the slots being carried out by means of two nozzles, a first nozzle being located at a first axial end of the stator inside the electrical conductors and a second nozzle being located at the other axial end of the stator outside the electrical conductors, step b) of application close to the slots comprising the following steps:
b1) applying the resin close to the slots,
b2) moving the nozzles so that the first nozzle is located outside the electrical conductors and the second nozzle is located inside the electrical conductors,
b3) applying the resin close to the slots.

8. The method according to claim 1, the stator being driven in rotation.

9. The method according to claim 1, comprising the following step:
e) polymerizing the resin deposited on the stator.

10. The method according to claim 1, the first temperature being between 80 and 160° C.

11. The method according to claim 1, the second temperature being between 110 and 190° C.

12. The method according to claim 1, a layer of resin with a thickness of between 0.05 mm and 2 mm being applied to the electrical connections.

13. The method according to claim 1, at least some of the electrical conductors, if not a majority of the electrical conductors, being in pin form, in particular in the form of U-pins or I-pins.

14. The method according to claim 1, the viscosity of the resin at the second temperature being higher than the viscosity of the resin at the first temperature.

15. The method according to claim 1, the resin comprising at least one polyester.

16. An electrical machine stator impregnated by a method according claim 1.

17. A stator for a rotary electric machine comprising a stator mass comprising slots, electrical conductors accommodated in the slots, at least two electrical conductors being electrically connected defining electrical connections, and comprising a resin comprising at least one polyester filling the slots and covering the electrical connections.
